(19) United States
(12) Patent Application Publication
(10) Pub. No.: US 2026/0288634 A1
(43) Pub. Date: Sep. 24, 2026

(54) APPARATUS AND OPERATION METHOD FOR PERFORMING GARBAGE COLLECTION IN A MEMORY SYSTEM

(71) Applicant: SK hynix Inc., Gyeonggi-do (KR)

(72) Inventors: Dong Hwan KOO, Gyeonggi-do (KR); Baek Gyun CHOI, Gyeonggi-do (KR); Da Young LIM, Gyeonggi-do (KR)

(21) Appl. No.: 19/292,913

(22) Filed: Aug. 7, 2025

(30) Foreign Application Priority Data
Mar. 18, 2025 (KR) 10-2025-0034523

(51) Int. Cl. G06F 12/02; G06F 3/06

(52) U.S. Cl. CPC G06F 12/0253; G06F 3/065; G06F 3/0652; G06F 3/0679; G06F 3/0613

(57) ABSTRACT

A memory system includes a memory device and a controller. The memory device includes a plurality of data storage areas. The controller is configured to perform a data input/output operation for the plurality of data storage areas based on first map data, and copy first map data used for the data input/output operation to generate second map data when determining that garbage collection is to be performed for at least one of the plurality of data storage areas, perform the garbage collection based on the second map data, and selectively update the first map data based on the second map data, which is modified by the garbage collection, based on a result of the data input/output operation.

### CROSS-REFERENCE TO RELATED APPLICATIONS

This patent application claims the benefit of Korean Patent Application No. 10-2025-0034523, filed on March 18, 2025, the entire disclosure of which is incorporated herein by reference.

### TECHNICAL FIELD

One or more embodiments of the present disclosure described herein relate to a data storage device or a memory system, and more specifically, to a device and an operating method for performing garbage collection in the data storage device or the memory system.

### BACKGROUND

A data processing system including a memory system or a data storage device has been developed to store more data in the data storage device, store data in the data storage device more quickly, and output data stored in the data storage device more quickly. The data storage device may include non-volatile memory cells and/or volatile memory cells for storing data. For example, in a memory system, a controller is configured to store data in an empty or blank space of a memory device. Unlike a conventional hard disk, it might be impossible to overwrite data in the memory device included in the memory system. The empty or blank space could be secured by an operation of erasing existing data, before new data is stored therein. To secure this empty or blank space, the data storage device or the memory system may perform garbage collection (GC).

### BRIEF DESCRIPTION OF THE DRAWINGS

The description herein makes reference to the accompanying drawings wherein like reference numerals refer to like parts throughout the figures.

FIG. 1 illustrates a data processing device according to an embodiment of the present disclosure.

FIG. 2 illustrates a data processing system according to an embodiment of the present disclosure.

FIG. 3 illustrates an embodiment of programming multi-bit data in a memory cell.

FIG. 4 illustrates an embodiment of programming multi-bit data in a memory cell.

FIG. 5 illustrates an operation performed within a memory system according to an embodiment of the present disclosure.

FIG. 6 illustrates an operation performed within a memory system according to an embodiment of the present disclosure.

FIG. 7 illustrates a memory system according to an embodiment of the present disclosure.

### DETAILED DESCRIPTION

Various embodiments of the present disclosure are described below with reference to the accompanying drawings. Elements and features of this disclosure may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms "comprise," "comprising," "include," and "including" are open-ended. As used in the appended claims, these terms specify the presence of the stated elements and do not preclude the presence or addition of one or more other elements. Furthermore, the terms in a claim do not foreclose the apparatus from including additional components, e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. The block/unit/circuit/component used with the "configured to" language include hardware, for example, circuits, memory storing program instructions executable to implement the operation, etc. Additionally, "configured to" can include a generic structure (e.g., generic circuitry) that is manipulated by software and/or firmware (e.g., an FPGA or a general-purpose processor executing software) to operate in a manner that is capable of performing the task(s) at issue. "Configured to" may also include adapting a manufacturing process (e.g., a semiconductor fabrication facility) to fabricate devices (e.g., integrated circuits) that are adapted to implement or perform one or more tasks.

As used in this disclosure, the term 'circuitry' or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of 'circuitry' or ‘logic’ applies to all uses of this term in this application, including in any claims. As a further example, as used in this application, the term "circuitry" or “logic” also covers an implementation of merely a processor (or multiple processors) or portion of a processor and its (or their) accompanying software and/or firmware. The term "circuitry" or “logic” also covers, for example, and if applicable to a particular claim element, an integrated circuit for a storage device.

As used herein, the terms "first," "second," "third," and so on are used as labels for nouns that the labels precede, and do not imply any type of ordering (e.g., spatial, temporal, logical, etc.). The terms "first" and "second" do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term "based on" is used to describe one or more factors that affect a determination. This term does not foreclose additional factors that may affect a determination. That is, a determination may be solely based on those factors or based, at least in part, on those factors. Consider the phrase "determine A based on B." While in this case, B is a factor that affects the determination of A, such a phrase does not foreclose the determination of A from also being based on C. In other instances, A may be determined based solely on B.

Herein, a data entry, an entry of data, an item of data, or a data item may be a sequence of bits. For example, the data entry may include the contents of a file, a portion of the file, a page in memory, an object in an object-oriented program, a digital message, a digital scanned image, a part of a video or audio signal, metadata or any other entity which can be represented by a sequence of bits. According to an embodiment, the data entry may include a discrete object. According to another embodiment, the data entry may include a unit of information processed or handled for a data input/output operation. According to another embodiment, the data entry may include a unit of information within a transmission packet between two different components.

Embodiments of the present disclosure can provide a memory device, a memory system including the memory device, a controller included in the memory system, or a data processing device including the memory system.

One embodiment of the present disclosure can provide an apparatus and an operation method for handling or processing a data input/output operation (e.g., a read/write operation) and a garbage collection operation in parallel, overcoming limitation of performing the garbage collection operation only while the data input/output operation is not performed in the memory system.

One embodiment of the present disclosure can provide an apparatus and an operation method for using copied map data for read/write operations during a garbage collection operation while performing multiple stages of program operations to store multiple bits of data in each memory cell in a memory system, thereby maintaining data consistency through selective update of original map data based on the copied map data.

In an embodiment, a memory system can include a memory device including a plurality of data storage areas; and a controller configured to perform a data input/output operation for the plurality of data storage areas based on first map data, and copy first map data used for the data input/output operation to generate second map data when determining that garbage collection is to be performed for at least one of the plurality of data storage areas, perform the garbage collection based on the second map data, and selectively update the first map data based on the second map data, which is modified by the garbage collection, based on a result of the data input/output operation.

The controller can be configured to perform the garbage collection while performing the data input/output operation.

The controller can be configured to perform the garbage collection regardless of whether the memory system is in an idle state.

The controller can be configured to update the first map data based on the data input/output operation and avoid updating the first map data based on the second map data modified by the garbage collection, when both the data input/output operation and the garbage collection are performed for a same logical address.

The controller can be configured to update the first map data based on the second map data modified by the garbage collection, when the data input/output operation and the garbage collection are performed for different logical addresses.

The controller can be further configured to: determine a source block or a target block for the garbage collection based on the second map data; and copies valid data from the source block or the target block to a destination block.

The controller can be further configured to perform an erase operation for the source block after the valid data is copied to the destination block.

The controller can be configured to select at least one of closed memory blocks as the source block or the target block, and select, as the destination block, at least one of open memory blocks on which a write operation is performed during the data input/output operation.

The controller can be configured to read and copy only valid data stored in the source block or the target block during the garbage collection.

The controller can be configured to avoid copying data associated with a logical address from a source block or a target block to a destination block during the garbage collection, when both the data input/output operation and the garbage collection are performed for a same logical address.

In another embodiment, a memory controller can include a first pipeline configured to process or carry out a data input/output command transmitted from a host and use first map data for a data input/output operation corresponding to the data input/output command; and a second pipeline distinct from the first pipeline and configured to copy the first map data to generate second map data, perform the garbage collection for at least one memory device based on the second map data, and update the first map data based on results of the garbage collection and the data input/output operation.

The second pipeline can perform the garbage collection while the first pipeline performs the data input/output operation.

The first pipeline can process or carries out the data input/output commands while the second pipeline performs the garbage collection.

The first map data can be updated by the first pipeline, after the first pipeline performs a write operation corresponding to a write command regarded as the data input/output command for a logical address while the second pipeline performs the garbage collection for the logical address.

The first map data can be updated by both the first pipeline and the second pipeline, after the first pipeline performs a write operation corresponding to a write command regarded as the data input/output commands for a logical address while the second pipeline performs the garbage collection for a different logical address.

The second pipeline can be configured to: determine a source block or a target block for the garbage collection based on the second map data; and copy valid data from the source block or the target block to a destination block.

The second pipeline can be configured to read and copy only valid data from the source block or the target block during the garbage collection.

In another embodiment, a method for operating a memory system can include receiving a data input/output command from a host; performing a data input/output operation corresponding to the data input/output command based on first map data; determining whether to perform garbage collection regardless of whether to perform the data input/output operation; copying the first map data for the garbage collection to generate second map data; performing the garbage collection based on the second map data; and performing map update of the first map data, used through the data input/output operation, based on a result of the garbage collection.

The map update of first map data can be performed by the data input/output operation performed corresponding to a write command regarded as the data input/output command for a logical address while the garbage collection is performed for the logical address.

The map update of first map data can be performed by the data input/output operation and the garbage collection after a write operation is performed corresponding to a write command regarded as the data input/output commands for a logical address while the garbage collection is performed for a different logical address.

Embodiments described herein can provide an apparatus and a method for improving a data input/output operation of a memory system or a data processing system. Embodiments will now be described with reference to the accompanying drawings, wherein like numbers reference like elements.

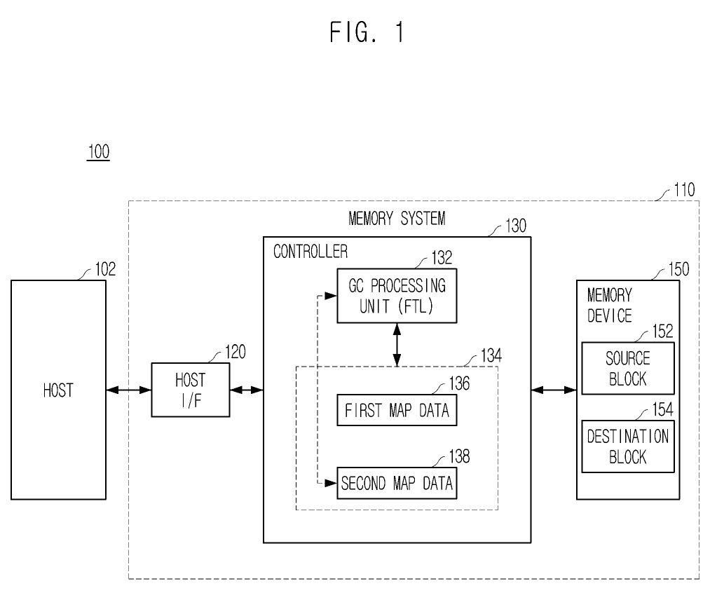

FIG. 1 illustrates a data processing device according to an embodiment of the present disclosure. Specifically, FIG. 1 is a block diagram illustrating a data processing device 100 in which a memory system 110 according to an embodiment of the present disclosure can serve as a data storage device of a host 102.

Referring to FIG. 1, the memory system 110 can include a memory device 150. The host 102 can utilize the memory device 150, including non-volatile memory cells, included in the memory system 110 to store data and retrieve stored data. For example, the memory device 150 can include at least one of any type of non-volatile memory such as MRAM, NAND, NOR, and HDD. In the following description, the memory device 150 is described as a non-volatile memory (NVM) for simplification and illustration purposes.

The host 102 can include a host memory (e.g., DRAM). According to an embodiment, the data processing device 100 can include a plurality of storage devices, such as the memory system 110. For example, the data processing device 100 can include a plurality of memory systems 110 configured as a redundant array of independent disks (RAID) that function together as mass storage devices for the host 102. Also, according to an embodiment, the data processing device 100 can include a plurality of computing devices, such as the host 102. For example, the data processing device 100 can include the memory system 110 configured as a shared memory device that the plurality of computing devices, such as the host 102, can use for data storage and retrieval.

The data processing device 100 can include the host 102 that is capable of storing and/or retrieving data in one or more storage devices (e.g., the memory system 110). As illustrated in FIG. 1, the host 102 can perform data communication with the memory system 110 via a host interface 120. The host 102 can include a wide range of devices, including mobility electronics such as automotive, electronic devices such as cell phones or MP3 players, computer servers, network attached storage (NAS) devices, desktop computers, notebook (i.e., laptop) computers, wearable devices, tablet computers, set-top boxes, telephones such as "smart" phones, "smart" pads, televisions, cameras, display devices, digital media players, video game consoles, video streaming devices, and the like.

According to an embodiment, the memory system 110 can include additional components not shown in FIG. 1 for clarity. For example, the memory system 110 can include a printed circuit board (PCB) including electrically conductive wiring, etc., to which components of the memory system 110 are mechanically attached, and electrically interconnecting components of the memory system 110. In some embodiments, the physical dimensions and connector configurations of the memory system 110 can conform to one or more standard form factors. For example, standard form factors can include, but are not limited to, 2.5-inch data storage devices (e.g., HDD or SSD), 2.5-inch data storage devices, 1.8-inch data storage devices, peripheral component interconnect (PCI), PCI expansion (PCI-X), PCI Express (PCIe) (e.g., PCIe x1, x4, x8, x16, PCIe Mini Card, MiniPCI, etc.). According to an embodiment, the memory system 110 can be directly connected (e.g., directly soldered) to a motherboard of the host 102.

The host interface 120 of the memory system 110 can include one or both of a data bus for exchanging data with the host 102 and a control bus for exchanging commands with the host 102. The host interface 120 can operate according to any suitable protocol. For example, the host interface 120 can operate according to one or more of advanced technology attachment (ATA) (e.g., serial ATA (SATA) and parallel ATA (PATA)), universal serial bus (USB), multi-media card (MMC), fiber channel protocol (FCP), small computer system interface (SCSI), serial attached SCSI (SAS), serial advanced technology attachment (SATA), mobile industry processor interface (MIPI), PCI, PCIe, NVMe (non-volatile memory express), OpenCAPI, GenZ, Cache Coherent Interface Accelerator (CCIX), Compute Express Link (CXL), open channel solid state drive (Open Channel SSD, OCSSD), or similar protocols. An electrical connection (e.g., a data bus, a control bus, or both) of the host interface 120 can be electrically connected to the controller 130 to provide an electrical connection between the host 102 and the controller 130 to exchange data between the host 102 and the controller 130. According to an embodiment, the electrical connection of the host interface 120 can allow the memory system 110 to receive power from the host 102. For example, a power supply related device of the memory system 110 can receive power from the host 102 via the host interface 120.

The memory system 110 can include a memory device 150 including a plurality of data storage areas. According to an embodiment, the memory device 150 can be configured to store and/or retrieve data. For example, a memory die or memory chip included in the memory device 150 can receive data from the controller 130 and a message or a command instructing the memory device to store the data. Similarly, a memory die or memory chip included in the memory device 150 can receive a message from the controller 130 instructing the memory device to retrieve the data. According to an embodiment, a memory die or memory chip included in the memory device 150 can be configured to store a relatively large amount of data (e.g., 128 MB, 256 MB, 412 MB, 1 GB, 2 GB, 3 GB, 8 GB, 16 GB, 22 GB, 54 GB, 128 GB, 256 GB, 412 GB, 1 TB, etc.).

According to an embodiment, the memory device 150 can include any type of non-volatile memory device, such as a Read Only Memory (ROM), a Mask ROM (MROM), a Programmable ROM (PROM), an Erasable ROM (EPROM), an Electrically Erasable ROM (EEPROM), a Phase change RAM (PRAM), a Magnetic RAM (MRAM), a NAND or NOR flash memory, a Phase Change Random Access Memory (PCRAM), a Resistive Random Access Memory (RRAM), a Ferroelectric Random Access Memory (FRAM), a Spin Transfer Torque Magnetic Random Access Memory (STT-MRAM), a holographic memory device, a hard disk drive (HDD), and any other type of nonvolatile memory device.

According to an embodiment, the memory device 150 can include a plurality of flash memory devices. The flash memory device can include a NAND or NOR based flash memory device and can store data based on an amount of charge contained in a floating gate of the transistor for each flash memory cell. In the NAND flash memory device, the flash memory device can be divided into a plurality of blocks, and the blocks can be divided into a plurality of pages. Each block of the plurality of blocks within a particular memory device can include a plurality of NAND cells. Rows of NAND cells can be electrically connected using word lines to establish the plurality of pages. Each cell in each of the plurality of pages can be electrically connected to a respective bit line. Additionally, the NAND flash memory device can be a 2D or 3D device. The flash memory device can include single level cells (SLC), multi-level cells (MLC), triple level cells (TLC), quad level cells (QLC), or higher-level cells. The controller 130 can write and read data to and from the NAND flash memory device at the page level and can erase data stored in the NAND flash memory device at the block level.

A portion of the memory device 150 can be formatted as a logical block, zone, or area such that a storage capacity of the memory device 150 is divided into multiple streams. Each stream can include multiple physical blocks or multiple erase blocks of the memory device 150. Each physical block can be associated with multiple logical blocks. Each logical block can be associated with a unique LBA or sector. Each stream can have a size that is tailored to a storage capacity of one or more physical blocks of the memory device 150. When the controller 130 receives a command, for example, from the host 102, the controller 130 can read and write data from multiple logical blocks associated with multiple physical blocks of the memory device 150.

The memory system 110 can include a power supply circuit configured to provide power to at least one component. When operating in a standard or normal mode, the power supply circuit can use power provided by an external device, such as the host 102, to power the one or more components. For example, the power supply circuit can power one or more components using power received from the host 102 via the host interface 120. According to an embodiment, the power supply circuit can include one or more power auxiliary devices configured to power one or more components when operating in a shutdown mode, such as when power input from an external device is interrupted. Examples of power auxiliary devices can include, but are not limited to, capacitors, supercapacitors, batteries, etc. According to an embodiment, the amount of power that can be stored by the one or more power storage components can correspond to a function of the cost and/or size (e.g., area/volume) of the one or more power storage components. As the amount of power stored by the one or more power storage components increases, the cost and/or size of the one or more power storage components can also increase.

The memory system 110 can also include a volatile memory device which the controller 130 may use to temporarily store data or information. The volatile memory device can include one or more volatile memories. For example, the controller 130 can use the volatile memory as a cache. The controller 130 can store cached data or information in the volatile memory until the cached data or information is completely written to the memory device 150. Examples of volatile memory can include, but are not limited to, RAM, DRAM, SRAM, and SDRAM (e.g., DDR1, DDR2, DDR3, DDR3L, LPDDR3, DDR4, LPDDR4, DDR5, LPDDR5, etc.).

Different types of volatile memories can be used with different access properties. For example, DRAM can be arranged for longer burst accesses to allow for improved bandwidth of the same access bus. Alternatively, DRAM can be used with smaller accesses so that random small accesses have better latency. The controller 130 can include additional optional SRAM and/or embedded MRAM. Embedded MRAM is another alternative memory that can be used in other embodiments. Similarly, while access to MRAM may be optimized for various design purposes, the amount of embedded MRAM in the controller 130 could be cost-sensitive. Thus, the choice of how much data and what data goes into premium non-volatile memory and premium volatile memory can be influenced by system tradeoffs.

The controller 130 in the memory system 110 can manage one or more tasks or operations of the memory system 110. For example, the controller 130 can include multiple pipelines for parallel processing. The controller 130 can include at least one processor or core supporting the multiple pipelines. Data input/output commands input from the host 102 or commands generated within the controller 130 can be divided into multiple stages and processed for the parallel processing. The multiple pipelines could divide tasks or operation corresponding to a processed command into multiple stages so that at least one processor or core can perform tasks or operations for multiple threads simultaneously or in parallel. According to an embodiment, the multiple pipelines can be configured to perform command processing through a superscalar technique that has multiple processors or cores capable of processing or handling the multiple pipelines.

A garbage collection processing unit 132 further included in the controller 130 can perform garbage collection (GC) through at least one pipeline that is performed through at least one processor or core. For example, the garbage collection processing unit 132 can determine whether to perform the garbage collection (GC) based on an operating status of the memory device 150. For example, the garbage collection processing unit 132 can determine whether to perform the garbage collection (GC) based on the number of free memory blocks which are capable of storing new data in the memory device 150, a ratio of empty or blank space to a total storage space of the memory device 150, or a update frequency or a write frequency of data stored in the memory device 150.

The controller 130 can perform a data input/output operation corresponding to a data input/output command transmitted through the host interface 120. According to an embodiment, the garbage collection processing unit 132 might not wait for an idle state in which the controller 130 does not process a data input/output command to perform the garbage collection (GC). The memory system 110 used in a place where large amounts of data are stored and processed, such as a data center, might not expect an idle state without any data input/output command transmitted from an external device. On the other hand, the memory system 110 might need to perform the garbage collection (GC) to erase data (e.g., invalid data) which is stored in the memory device 150 but is no longer used and to secure an empty or blank space (e.g., a free memory block) for storing new data. The garbage collection processing unit 132 can determine whether to perform the garbage collection (GC) regardless of the idle state.

When it is determined to perform the garbage collection (GC), the garbage collection processing unit 132 can control map data 134 stored in the controller 130. First map data 136 among the map data 134 can be used for data input/output operations performed by the controller 130. Because the garbage collection can be performed even when not in an idle state, the garbage collection processing unit 132 in the controller 130 can copy the first map data 136 to generate second map data 138 for performing garbage collection. The garbage collection processing unit 132 can perform the garbage collection (GC) based on the second map data 138. After performing garbage collection, the garbage collection processing unit 132 can perform a map update according to data copy or migration on the first map data 136.

The garbage collection processing unit 132 can selectively update the first map data 136 according to a result of the data input/output operation for data copy or migration through the garbage collection (GC). The garbage collection (GC) can change locations of data in the memory device 150. Because the memory device 150 is not overwritten, the write operation among the data input/output operations performed by the controller 130 can also change the locations of the data within the memory device 150. Because the garbage collection (GC) that may change the locations of the data and the write operation among the data input/output operations can be performed in parallel, a data collision or a problem with data consistency could occur. Therefore, when the write operation corresponding to the write command among the data input/output commands is performed while the garbage collection (GC) is performed for a same logical address, the update of the first map data 136 can be performed based on the data input/output operation, not the garbage collection. This is because the data copied and migrated by the garbage collection becomes old and invalid data as compared to the data stored by the data input/output operation.

On the other hand, when the write operation corresponding to the write command among the data input/output commands while the garbage collection is performed for a different logical address, the update of the first map data 136 can be performed based on the garbage collection and the data input/output operation. Because there are no data collisions or data consistency issues due to the garbage collection and the write operation, the results of all operations could be reflected in the first map data 136.

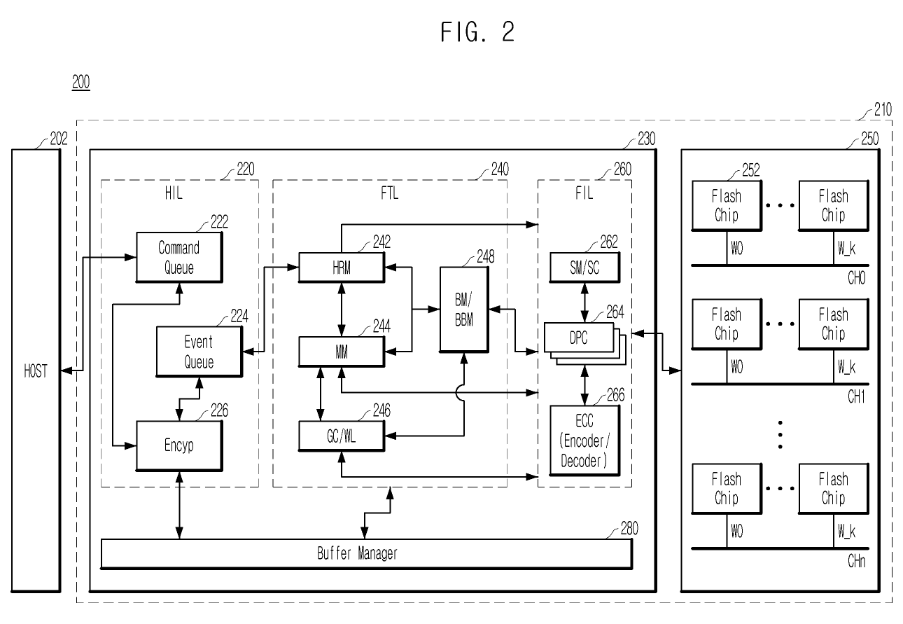

FIG. 2 illustrates a data processing system according to an embodiment of the present disclosure.

Referring to FIG. 2, the data processing system 200 may include a host 202 engaged or coupled with a memory system 210. For example, the host 202 and the memory system 210 can be coupled to each other via a data bus, a host cable and the like to perform data communication. According to an embodiment, the data processing system 200 can correspond to the data processing system 100.

The memory system 210 may include a memory device 250 and a controller 230. The memory device 250 and the controller 230 in the memory system 210 may be considered components or elements physically separated from each other. The memory device 250 and the controller 230 may be connected via at least one data path. For example, the data path may include a channel and/or a way. According to an embodiment, the memory device 250 can include the memory device 150 shown in FIG. 1

The memory device 250 can include plural memory chips (e.g., flash chips) 252 coupled to the controller 230 through plural channels CH0, CH1, …, CHn and ways W0, …, W_k. The memory chip 252 can include a plurality of memory planes or a plurality of memory dies. According to an embodiment, the memory plane may be considered a logical or a physical partition including at least one memory block, a driving circuit capable of controlling an array including a plurality of non-volatile memory cells, and a buffer that can temporarily store data inputted to, or outputted from, non-volatile memory cells. Each memory plane or each memory die can support an interleaving mode in which plural data input/output operations are performed in parallel or simultaneously. According to an embodiment, memory blocks included in each memory plane, or each memory die, included in the memory device 250 can be grouped to input/output plural data entries as a super memory block. An internal configuration of the memory device 250 shown in FIG. 2 may be changed based on operating performance of the memory system 210. An embodiment of the present disclosure may not be limited to the internal configuration described in FIG. 2.

According to an embodiment, the memory device 250 and the controller 230 may be components or elements functionally divided. Further, according to an embodiment, the memory device 250 and the controller 230 may be implemented with a single chip or a plurality of chips.

The controller 230 may perform a data input/output operation (such as a read operation, a program operation, an erase operation, etc.) in response to a request or a command input from an external device such as the host 202. For example, when the controller 230 performs a read operation in response to a read request input from an external device, data stored in a plurality of non-volatile memory cells included in the memory device 250 is transferred to the controller 230. Further, the controller 230 can independently perform an operation regardless of the request or the command input from the host 202. Regarding an operating state of the memory device 250, the controller 230 can perform an operation such as garbage collection (GC), wear leveling (WL), a bad block management (BBM) for checking whether a memory block is bad and handling a bad block.

Each memory chip 252 can include a plurality of memory blocks. The memory blocks may be understood to be a group of non-volatile memory cells in which data is removed together by a single erase operation. Although not illustrated, the memory block may include a page which is a group of non-volatile memory cells that store data together during a single program operation or output data together during a single read operation. For example, one memory block may include a plurality of pages. The memory device 250 may include a voltage supply circuit capable of supplying at least one voltage into the memory block. The voltage supply circuit may supply a read voltage Vrd, a program voltage Vprog, a pass voltage Vpass, or an erase voltage Vers into a non-volatile memory cell included in the memory block.

The host 202, which interworks with the memory system 210, or the data processing system 210 (including the memory system 210 and the host 202) may be a mobility electronic device (such as a vehicle), a portable electronic device (such as a mobile phone, an MP3 player, a laptop computer, or the like), and a non-portable electronic device (such as a desktop computer, a game machine, a TV, a projector, or the like). The host 202 may provide interaction between the host 202 and a user using the data processing system 200 or the memory system 210 through at least one operating system (OS). The host 202 transmits a plurality of commands corresponding to a user’s request to the memory system 210, and the memory system 210 performs data input/output operations corresponding to the plurality of commands (e.g., operations corresponding to the user’s request).

Referring to FIG. 2, the controller 230 in the memory system 210 can operate along with the host 202 and the memory device 250. As illustrated, the controller 230 may include a layered structure including the host interface layer (HIL) 220, a flash translation layer (FTL) 240, and a flash interface layer (FIL, or a memory interface layer) 260.

The host interface layer (HIL) 220, the flash translation layer (FTL) 240, and the flash interface layer (FIL) 260 described in FIG. 2 are illustrated as one embodiment. The host interface layer (HIL) 220, the flash translation layer (FTL) 240, and the flash interface layer (FIL) 260 may be implemented in various forms according to the operating performance of the memory system 210. According to an embodiment, the host interface layer (HIL) 220, the flash translation layer (FTL) 240, and the flash interface layer (FIL) 260 can perform operations through multi cores or processors having a pipelined structure included in the controller 230.

The host 202 and the memory system 210 may use a predetermined set of rules or procedures for data communication or a preset interface to transmit and receive data therebetween. Examples of sets of rules or procedures for data communication standards or interfaces supported by the host 202 and the memory system 210 for sending and receiving data include Universal Serial Bus (USB), Multi-Media Card (MMC), Parallel Advanced Technology Attachment (PATA), Small Computer System Interface (SCSI), Enhanced Small Disk Interface (ESDI), Integrated Drive Electronics (IDE), Peripheral Component Interconnect Express (PCIe or PCI-e), Serial-attached SCSI (SAS), Serial Advanced Technology Attachment (SATA), Mobile Industry Processor Interface (MIPI), and the like. According to an embodiment, the host 202 and the memory system 210 may be coupled to each other through a Universal Serial Bus (USB). The Universal Serial Bus (USB) is a highly scalable, hot-pluggable, plug-and-play serial interface that ensures cost-effective, standard connectivity to peripheral devices such as keyboards, mice, joysticks, printers, scanners, storage devices, modems, video conferencing cameras, and the like.

The memory system 210 may support the non-volatile memory express (NVMe). The Non-volatile memory express (NVMe) is a type of interface based at least on a Peripheral Component Interconnect Express (PCIe) designed to increase performance and design flexibility of the host 202, servers, computing devices, and the like equipped with the non-volatile memory system 210. The PCIe can use a slot or a specific cable for connecting a computing device (e.g., host 202) and a peripheral device (e.g., memory system 210). For example, the PCIe can use a plurality of pins (e.g., 18 pins, 32 pins, 49 pins, or 82 pins) and at least one wire (e.g., x1, x4, x8, or x16) to achieve high speed data communication over several hundred MB per second. According to an embodiment, the PCIe scheme may achieve bandwidths of tens to hundreds of Giga bits per second.

A buffer manager 280 included in the controller 230 can control the input/output of data or operation information in conjunction with the host interface layer (HIL) 220, the flash translation layer (FTL) 240, and the flash interface layer (FIL) 260. To this end, the buffer manager 280 can set or establish various buffers, caches, or queues in a memory, and control data input/output of the buffers, the caches, or the queues, or data transmission between the buffers, the caches, or the queues in response to a request or a command generated by the host interface layer (HIL) 220, the flash translation layer (FTL) 240, and the flash interface layer (FIL) 260. For example, the controller 230 may temporarily store read data provided from the memory device 250 in response to a request from the host 202 before providing the read data to the host 202. Also, the controller 230 may temporarily store write data provided from the host 202 in a memory before storing the write data in the memory device 250. When controlling operations such as a read operation, a program operation, and an erase operation performed within the memory device 250, the read data or the write data transmitted or generated between the controller 230 and the memory device 250 in the memory system 210 could be stored and managed in a buffer, a queue, etc. established in the memory by the buffer manager 280. Besides the read data or the write data, the buffer manager 280 can store signal or information (e.g., map data, a read command, a program command, or etc. which is used for performing operations such as programming and reading data between the host 202 and the memory device 250) in the buffer, the cache, the queue, etc. established in the memory. The buffer manager 280 can set, or manage, a command queue, a program memory, a data memory, a write buffer/cache, a read buffer/cache, a data buffer/cache, a map buffer/cache, etc.

The host interface layer (HIL) 220 may handle commands, data, and the like transmitted from the host 202. By way of example but not limitation, the host interface layer 220 may include a command queue manager 222 and an event queue manager 224. The command queue manager 222 may sequentially store the commands, the data, and the like received from the host 202 in a command queue, and output them to the event queue manager 224, for example, in an order in which they are stored in the command queue manager 222. The event queue manager 224 may sequentially transmit events for processing the commands, the data, and the like received from the command queue. According to an embodiment, the event queue manager 224 may classify, manage, or adjust the commands, the data, and the like received from the command queue. Further, according to an embodiment, the host interface layer 220 can include an encryption manager (Encyp) 226 configured to encrypt a response or output data to be transmitted to the host 202 or to decrypt an encrypted portion in the command or data transmitted from the host 202.

A plurality of commands or data of the same characteristic may be transmitted from the host 202, or a plurality of commands and data of different characteristics may be transmitted to the memory system 210 after being mixed or jumbled by the host 202. For example, a plurality of commands for reading data, i.e., read commands, may be delivered, or commands for reading data, i.e., a read command, and a command for programming/writing data, i.e., a write command, may be alternately transmitted to the memory system 210. The command queue manager 222 of the host interface layer 220 may sequentially store commands, data, and the like, which are transmitted from the host 202, in the command queue. Thereafter, the host interface layer 220 may estimate or predict what type of internal operations the controller 230 will perform according to the characteristics of the commands, the data, and the like, which have been transmitted from the host 202. The host interface layer 220 may determine a processing order and a priority of commands, data and the like based on their characteristics. According to the characteristics of the commands, the data, and the like transmitted from the host 202, the event queue manager 224 in the host interface layer 220 is configured to receive an event, which should be processed or handled internally within the memory system 210 or the controller 230 according to the commands, the data, and the like input from the host 202, from the buffer manager 280. Then, the event queue manager 224 can transfer the event including the commands, the data, and the like into the flash translation layer (FTL) 240.

According to an embodiment, the flash translation layer (FTL) 240 may include a host request manager (HRM) 242, a map manager (MM) 244, a state manager (GL/WL) 246, and a block manager BM/BBM) 248. Further, according to an embodiment, the flash translation layer (FTL) 240 may implement a multi-thread scheme to perform data input/output (I/O) operations. A multi-thread FTL may be implemented through a multi-core processor using multi-thread included in the controller 230. For example, the host request manager (HRM) 242 may manage the events transmitted from the event queue. The map manager (MM) 244 may handle or control map data. The state manager 246 may perform an operation such as garbage collection (GC) or wear leveling (WL), after checking an operating state of the memory device 250. The block manager 248 may execute commands or instructions onto a block in the memory device 250.

The host request manager (HRM) 242 may use the map manager (MM) 244 and the block manager 248 to handle or process requests according to read and program commands and events which are delivered from the host interface layer 220. The host request manager (HRM) 242 may send an inquiry request to the map manager (MM) 244 to determine a physical address corresponding to a logical address which is entered with the events. The host request manager (HRM) 242 may send a read request with the physical address to the flash interface layer 260 to process the read request, i.e., handle the events. In one embodiment, the host request manager (HRM) 242 may send a program request (or a write request) to the block manager 248 to program data to a specific empty page storing no data in the memory device 250, and then may transmit a map update request corresponding to the program request to the map manager (MM) 244 in order to update an item relevant to the programmed data in information of mapping the logical and physical addresses to each other. According to an embodiment, the map manager 244 can manage the map data 134 described in FIG. 1. For example, the map manager 244 can determine setting of a memory space or area capable of storing the first map data 136 and the second map data 138, or, the map manager 244 can generate or delete the second map data 138 in response to a request of the garbage collection processing unit 132 described in FIG. 1.

The block manager 248 may convert a program request delivered from the host request manager (HRM) 242, the map manager (MM) 244, and/or the state manager 246 into a flash program request used for the memory device 250, to manage flash blocks in the memory device 250. To maximize or enhance program or write performance of the memory system 210, the block manager 248 may collect program requests and send flash program requests for multiple-plane and one-shot program operations to the flash interface layer 260. In an embodiment, the block manager 248 sends several flash program requests to the flash interface layer 260 to enhance or maximize parallel processing of a multi-channel and multi-directional flash controller.

In an embodiment, the block manager 248 may manage blocks in the memory device 250 according to the number of valid pages, select and erase blocks having no valid pages when a free block is needed and select a block including the least number of valid pages when it is determined that garbage collection is to be performed. According to an embodiment, the block manager 248 can correspond to the garbage collection processing unit 132 shown in FIG. 1. The state manager 246 may perform garbage collection to move valid data stored in the selected block to an empty block and erase data stored in the selected block so that the memory device 250 may have enough free blocks (i.e., empty blocks with no data).

When the block manager 248 provides information regarding a block to be erased to the state manager 246, the state manager 246 may check all flash pages of the block to be erased to determine whether each page of the block is valid. For example, to determine validity of each page, the state manager 246 may identify a logical address recorded in an out-of-band (OOB) area of each page. To determine whether each page is valid, the state manager 246 may compare a physical address of the page with a physical address mapped to a logical address obtained from an inquiry request. The state manager 246 sends a program request to the block manager 248 for each valid page. A map table may be updated by the map manager 244 when a program operation is complete.

The map manager 244 may manage map data, e.g., a logical-physical map table. The map manager 244 may process various requests, for example, queries, updates, and the like, which are generated by the host request manager (HRM) 242 or the state manager 246. The map manager 244 may store the entire map table in the memory device 250, e.g., a flash/non-volatile memory, and cache mapping entries according to the storage capacity of the memory. When a map cache miss occurs while processing inquiry or update requests, the map manager 244 may send a read request to the flash interface layer 260 to load a relevant map table stored in the memory device 250. When the number of dirty cache blocks in the map manager 244 exceeds a certain threshold value, a program request may be sent to the block manager 246, so that a clean cache block is made and a dirty map table may be stored in the memory device 250.

When garbage collection is performed, the state manager 246 copies valid page(s) into a free block, and the host request manager (HRM) 242 may program the latest version of the data for the same logical address of the page and concurrently issue an update request. When the state manager 246 requests the map update in a state in which the copying of the valid page(s) is not completed normally, the map manager 244 may not perform the map table update. This is because the map request is issued with old physical information when the state manager 246 requests the map update and a valid page copy is completed later. The map manager 244 may perform a map update operation to ensure accuracy when, or only if, the latest map table still points to the old physical address.

The flash interface layer (FIL) 260 may exchange data, commands, state information, and the like, with a plurality of memory chips 252 in the memory device 250 through a data communication method. According to an embodiment, the flash interface layer 260 may include a status check schedule manager (SM/SC) 262 and a data path manager (DPC) 264. The status check schedule manager 262 can check and determine the operating state regarding the plurality of memory chips 252 coupled to the controller 230, the operating state regarding a plurality of channels CH0, CH1, ..., CHn and the plurality of ways W0, ..., W_k, and the like. The transmission and reception of data or commands can be scheduled in response to the operating states regarding the plurality of memory chips 252 and the plurality of channels CH0, CH1, ..., CHn. The data path manager 264 can control the transmission and reception of data, commands, etc. through the plurality of channels CH0, CH1, ..., CHn and ways W0, ..., W_k based on the information transmitted from the status check schedule manager 262. According to an embodiment, the data path manager 264 may include a plurality of transceivers, each transceiver corresponding to each of the plurality of channels CH0, CH1, ..., CHn. Further, according to an embodiment, the status check schedule manager 262 and the data path manager 264 included in the flash interface layer 260 could be implemented as, or engaged with, a memory control sequence generator.

According to an embodiment, the flash interface layer 260 may further include an ECC (error correction code) circuitry 266 configured to perform error checking and correction of data transferred between the controller 230 and the memory device 250. The ECC circuitry 266 may be implemented as a separate module, circuit, or firmware in the controller 230, but may also be implemented in each memory chip 252 included in the memory device 250 according to an embodiment. The ECC circuitry 266 may include a program, a circuit, a module, a system, or an apparatus for detecting and correcting an error bit of data processed by the memory device 250.

For finding and correcting any error of data transferred from the memory device 250, the ECC circuitry 266 can include an error correction code (ECC) encoder and an ECC decoder. The ECC encoder may perform error correction encoding of data to be programmed in the memory device 250 to generate encoded data into which a parity bit is added and store the encoded data in the memory device 250. The ECC decoder can detect and correct error bits contained in the data read from the memory device 250 when the controller 230 reads the data stored in the memory device 250. For example, after performing error correction decoding on the data read from the memory device 250, the ECC circuitry 266 can determine whether the error correction decoding has succeeded or not, and outputs an instruction signal, e.g., a correction success signal or a correction fail signal, based on a result of the error correction decoding. The ECC circuitry 266 may use a parity bit, which has been generated during the ECC encoding process for the data stored in the memory device 250, to correct the error bits of the read data entries. When the number of the error bits is greater than or equal to the number of correctable error bits, the ECC circuitry 266 may not correct the error bits and instead may output the correction fail signal indicating failure in correcting the error bits.

According to an embodiment, the error correction circuitry 266 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), or the like. The error correction circuitry 266 may include all circuits, modules, systems, and/or devices for performing the error correction operation based on at least one of the above-described codes.

For example, the encoder in the ECC circuitry 266 may generate a codeword that is a unit of ECC-applied data. A codeword of length n bits may include k bits of user data and (n-k) bits of parity. A code rate may be calculated as (k/n). The higher the code rate, the more user data that can be stored in a given codeword. When the length of the codeword is longer and the code rate is smaller, the error correction capability of the ECC circuitry 266 could be improved. In addition, the ECC circuitry 266 performs decoding using information read from the channels CH0, CH1, ..., CHn. The decoder in the ECC circuitry 266 can be classified into a hard decision decoder and a soft decision decoder according to how many bits represent the information to be decoded. A hard decision decoder performs decoding with a memory cell output information expressed in 1 bit, and the 1-bit information used at this time is called hard decision information. A soft decision decoder uses more accurate memory cell output information composed of 2 bits or more, and this information is called soft decision information. The ECC circuitry 266 may correct errors included in data using the hard decision information or the soft decision information.

According to an embodiment, to increase the error correction capability, the ECC circuitry 266 may use a concatenated code using two or more codes. In addition, the ECC circuitry 266 may use a product code that divides one codeword into several rows and columns and applies a different relatively short ECC to each row and column.

In accordance with an embodiment, a manager included in the host interface layer 220, the flash translation layer (FTL) 240, and the flash interface layer (FIL) 260 could be implemented with a general processor, an accelerator, a dedicated processor, a co-processor, a multi-core processor, or the like. According to an embodiment, the manager can be implemented with firmware working with a processor.

According to an embodiment, the memory device 250 is embodied as a non-volatile memory such as a flash memory, for example, a Read Only Memory (ROM), a Mask ROM (MROM), a Programmable ROM (PROM), an Erasable ROM (EPROM), an Electrically Erasable ROM (EEPROM), a Magnetic RAM (MRAM), a NAND flash memory, a NOR flash memory, or the like. In another embodiment, the memory device 250 may be implemented by at least one of a phase change random access memory (PCRAM), a Resistive Random Access Memory (ReRAM), a ferroelectrics random access memory (FRAM), a transfer torque random access memory (STT-RAM), and a spin transfer torque magnetic random access memory (STT-MRAM), or the like.

According to an embodiment, the memory system 210 may support dividing a storage area in which data entries are stored in the memory device 250 based on a preset standard and dedicating each of divided areas to a specific range of logical block addresses (LBA). When supporting zoned namespaces, the memory system 210 can increase access efficiency and reduce an access time by using a logical block address range dedicated for each area rather than using a specific logical block address range that spans multiple areas. For example, zoned namespaces can improve write performance, which can be useful for workloads that require sequential writes of large amounts of data, such as video streaming or data backup.

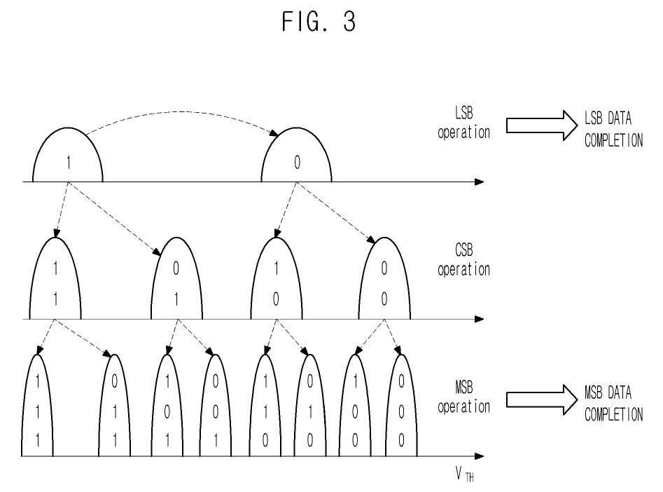

FIG. 3 illustrates an operation of programming multi-bit data in accordance with an embodiment of the present disclosure. Specifically, FIG. 3 illustrates a two-step program operation for storing 3-bit data in a non-volatile memory cell.

Referring to FIG. 3, a non-volatile memory cell can have a threshold voltage of an erased state before a data program operation is performed. When a first-step program operation is performed, LSB data may be programmed into the non-volatile memory cell. Thereafter, when a second-step program operation is performed, CSB data and MSB data can be programmed in the non-volatile memory cell. A threshold voltage of the non-volatile memory cell may have one of eight different levels after the first-step program operation and the second-step program operation are performed. Herein, eight different threshold voltage levels which the non-volatile memory cell can have can indicate three-bit data of ‘111’, ‘011’, ‘101’, ‘001’, ‘110’, ‘010’, ‘100’, and ‘000’.

The memory device 250, 150 shown in FIGS. 1 and 2 can take a long time to store multi-bit data. As described with reference to FIG. 3, when the first-step program operation is successfully completed, the memory device 250, 150 may notify a completion notice regarding the LSB data (LSB DATA COMPLETION). Thereafter, the memory device 250, 150 can program the CSB data and the MSB data through a second-step program operation. When the second-step program operation is successfully completed, the memory device 250, 150 can provide a completion notification (MSB DATA COMPLETION) for the CSB data and the MSB data.

Although it has been described in FIG. 3 that 3-bit data can be programmed in the non-volatile memory cell by a two-step program operation, in other embodiments 3-bit data can be programmed through a three-step program operation. For example, when programming in a three-step program operation, the memory device 250, 150 may transfer each completion notice regarding each of LSB data, CSB data, and MSB data.

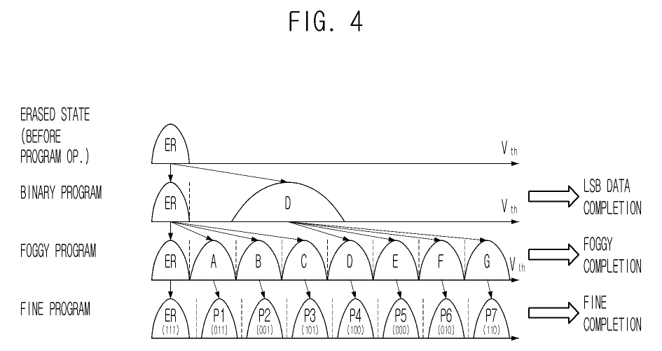

FIG. 4 illustrates programming of multi-bit data in accordance with an embodiment of the present disclosure. Specifically, FIG. 4 illustrates a two-step program operation for storing 3-bit data in a non-volatile memory cell.

Referring to FIG. 4, a non-volatile memory cell can have a threshold voltage of an erased state before a data program operation is performed. The memory device 250, 150 may first perform a partial program operation based on LSB data to be stored in a non-volatile memory cell. Here, the partial program operation can include a binary programming operation in which a threshold voltage of a nonvolatile memory cell is greatly increased by using a very large ISPP step pulse. After performing the binary programming operation, the memory device 250, 150 can transfer a completion notification (LSB DATA COMPLETION) for the LSB data.

After the binary programming operation is performed, the memory device 250, 150 may program the non-volatile memory cell based on CSB and MSB data again. In this step, the threshold voltage of the non-volatile memory cell can be increased by using an ISPP step pulse smaller than that of the binary programming operation. This process can be referred to as a foggy program operation. Thereafter, the memory device 250, 150 may perform a fine program operation to narrow threshold voltage distributions of non-volatile memory cells. The fine program operation can use smaller ISPP step pulses than that used in a foggy program operation.

Unlike the binary program operation or the foggy program operation, the fine program operation can include a process of narrowing the threshold voltage distributions of the non-volatile memory cells. Accordingly, the possibility of errors can increase during the fine program operation. In an embodiment, the memory device 250, 150 can store the multi-bit data (all bit values), which are to be programmed, in the SLC buffer after the binary program operation and the foggy program operation. For another example, the memory device 250, 150 can notify completion of the foggy program operation after the foggy program operation is performed. Also, the memory device 250, 150 may notify the completion of the fine program operation (FINE COMPLETION) after the fine program is performed.

As described above, referring to FIGS. 3 and 4, a procedure of storing the multi-bit data in the memory device 250, 150 may be performed by a plurality of step program operations. When at least some step program operations of the memory device 250, 150 are successfully completed, a completion notification could be output to the controller 230, 130. Moreover, the procedure of storing multi-bit data in the memory device 250, 150 might not be performed at a specific location, but may be performed simultaneously, in parallel, or sequentially within a range including plural locations.

Although FIGS. 3 and 4 illustrate a procedure of storing 3 bits of data in each memory cell included in a memory device 150, 250, 4 or 5 bits of data can be stored in each memory cell. 4 bits of data can be programmed through two-step program operations. For example, in a case of storing 4 bits of data in each memory cell, the memory system 110, 210 can first store 2 bits of data out of 4 bits of data in the memory cell through a foggy program operation and then store the remaining 2 bits of data out of 4 bits of data through a fine program operation.

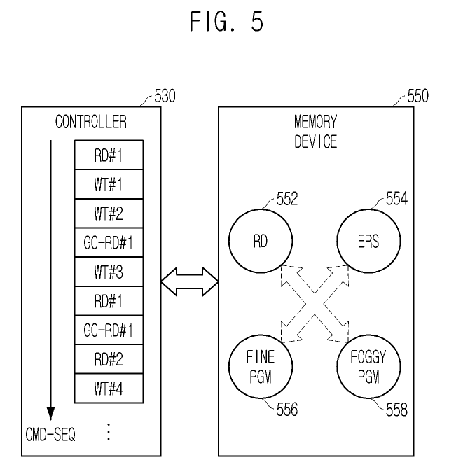

FIG. 5 illustrates an operation performed within a memory system according to an embodiment of the present disclosure.

Referring to FIG. 5, the memory system can include a controller 530 and a memory device 550. The controller 530 and the memory device 550 can correspond to the controllers 130, 230 and the memory devices 150, 250 described in FIGS. 1 and 2.

The controller 530 can sequentially transmit a plurality of commands (e.g., RD#1, WT#1, WT#2, …, WT#4, etc.) to the memory device 550. The memory device 550 can sequentially perform tasks or operations corresponding to the plurality of commands (e.g., RD#1, WT#1, WT#2, …, WT#4, etc.) transmitted from the controller 530. The controller 530 can process or handle data input/output commands transmitted from an external device and other commands generated internally to determine a command transmission order CMD-SEQ regarding the plurality of commands (e.g., RD#1, WT#1, WT#2, …, WT#4, etc.) which are to be transmitted to the memory device 550.

The plurality of commands transmitted from the controller 530 to the memory device 550 can be determined through a predetermined scheme or schedule (e.g., a protocol) such as a read command, a write command, a delete command, a status check command, etc. The read command transmitted by the controller 530 to the memory device 550 might not vary depending on whether it is transmitted from an external device or internally generated for the garbage collection (GC). However, to help understand an embodiment of the present disclosure, shown in FIG. 5, read commands RD#1, RD#2 and write commands WT#1, WT#2, WT#3, WT#4 can be examples of data input/output commands transmitted from an external device. A garbage collection read command GC-RD#1 and a garbage collection write command GC-WT#1 can be examples of commands generated internally.

The memory device 550, which is configured to receive and execute an operation or task corresponding to a command transmitted from the controller 530, might not determine whether the transmitted command is from the external device (e.g., a host) or is generated during a background operation such as the garbage collection (GC). The memory device 550 can be configured to sequentially execute operations or tasks corresponding to the commands transmitted from the controller 530 and transmit results of the execution (e.g., read data, write completion, etc.) to the controller 530. The memory device 550 can transition to an operation state such as a read state 552, a delete state 554, a fine program state 556, and a foggy program state 558 in response to a command transmitted from the controller 530, so that the memory device 550 could perform the operation or task associated with the transmitted command.

According to an embodiment, to perform the garbage collection (GC), the controller 530 might not wait for an idle state in which there is no data input/output command input from the external device. The controller 530 can perform the garbage collection while processing and handling a data input/output command transmitted from the external device. In this case, the data input/output command input from the outside and the garbage collection might occur for data corresponding to a same logical address. The controller 530 can determine or check whether program operations associated with the data input/output command and the garbage collection are performed for the same logical address. The procedures for avoiding or blocking at least some tasks or operations for the corresponding logical address and avoiding or preventing a data collision regarding the corresponding logical address, which are necessary or required for maintaining data consistency, might become very complicated. To solve this issue, when determining to perform the garbage collection, the controller 530 can copy the first map data 136 (see, FIG. 1) used for operations or tasks corresponding to the data input/output command to generate the second map data 138 (see, FIG. 1). The controller 530 can process the data input/output command based on the first map data 136 and perform an operation corresponding to the data input/output command. In parallel, the controller 530 can perform the garbage collection based on the second map data 138. After performing the garbage collection, the controller 530 can perform a map update on the first map data 136 based on a result of garbage collection (e.g., copied or migrated data).

The map update could be selectively performed in response to the operation result corresponding to the data input/output command to avoid or prevent data collision and maintain data consistency. For example, while the garbage collection (GC) is performed, a write operation corresponding to a write command among data input/output commands can be performed for the same logical address as the garbage collection. In this case, the data copied or migrated by the garbage collection is older than the data which is stored in the memory device 550 by the write command. The older copied or migrated data corresponding to the same logical address could become invalid. Therefore, a map update for the data copied and migrated by the garbage collection could be blocked or excluded. That is, for the corresponding logical address, the update of the first map data 136 can be performed based on the data input/output operation, not the garbage collection.

On the other hand, while the garbage collection is performed for data associated with a logical address, a write operation associated with a write command among the data input/output commands can be performed for a different logical address. In this case, both data copied and migrated by the garbage collection and data stored in the memory device 550 by the write command could be determined as valid data. Accordingly, the update of the first map data 136 for the corresponding logical addresses can be performed based on the garbage collection and data input/output operations. When it is determined that no data collision or data integrity problem occurs due to garbage collection and write operations, the controller 530 can reflect the results of both the operations to the first map data 136.

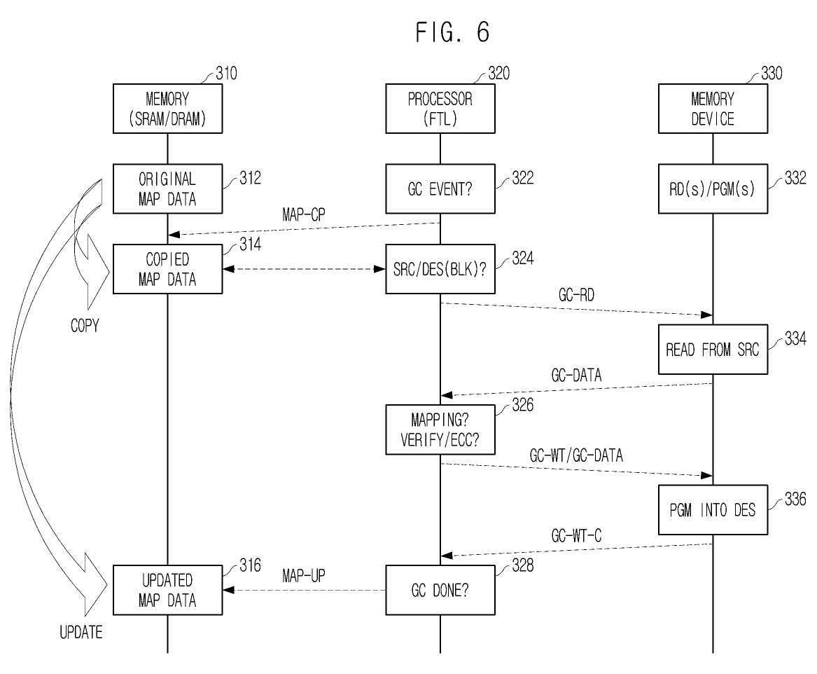

FIG. 6 illustrates an operation performed within a memory system according to an embodiment of the present disclosure. Specifically, FIG. 6 describes operations of major components for the garbage collection performed within the memory system.

Referring to FIGS. 1 to 6, operations of the garbage collection (GC) performed through a processor 320, a memory 310, and a memory device 330 corresponding to the controller 130, 230, 530 among various components included in the memory system will be described. The processor 320 can correspond to at least one processor or core included in the controller 130, 230, 530. In addition, according to an embodiment, the processor 320 may correspond to the flash translation layer (FTL) 240 described in FIG. 2. The memory device 330 may correspond to the memory device 150, 250, 550 described in FIGS. 1, 2, and 5.

FIG. 6 describes commands for the garbage collection or data copied or migrated through the garbage collection separately from commands or data corresponding to the data input/output operations. Herein, these commands are distinguished for describing the garbage collection. The commands transmitted between the processor 320 and the memory device 330 might not vary depending on the data input/output operation and the garbage collection.

According to an embodiment, the memory 310 can include at least one of a volatile memory (e.g., SRAM), included in the controller 130, 230, 530, or a volatile memory (e.g., DRAM) which is connected to the controller 130, 230, 530 and accessed through an additional interface. The processor 320 could selectively use an available memory 310 to improve performance of the data input/output operation and the garbage collection.

The processor 320 can process data input/output commands, and the memory device 330 can perform read operations and program operations RD(s)/PGM(s) (operation 332). When the processor 320 processes the data input/output commands, the memory 310 can store or load the original of the map data 312.

The processor 320 may determine whether to perform the garbage collection 322. After the processor 320 determines to perform garbage collection, the processor 320 can copy the original of the map data to another space of the memory 310 to generate a copy of the map data (operation 314).

The processor 320 can determine a source block SRC for the garbage collection (GC) based on the copy of the map data (operation 324). Here, the source block SRC can be a memory block where some valid data is stored and a target memory block to be erased after the garbage collection. The processor 320 can store valid data stored in the source block SRC in a destination block DES. The destination block DES can be an open memory block in the memory device 330. According to an embodiment, the processor 320 can determine the destination block DES based on the copy of the map data.

After determining the source block SRC, the processor 320 can transmit a garbage collection read command GC-RD to read data of the source block SRC to the memory device 330. The memory device 330 can read data from the source block SRC (operation 334), and the memory device 330 can transmit garbage collection data GC-DATA to the processor 320.

The processor 320 can be configured to verify the garbage collection data GC-DATA or check for an error and determine to store the data in a new location such as the destination block DES (operation 326). The processor 320 can be configured to generate map information that links a logical address for the corresponding data and a physical address pointing to a new location in the memory device 330 (operation 326).

The processor 320 can transmit a garbage collection write command GC-WT and garbage collection data GC-DATA to be stored in the destination block DES in the memory device 330.

The memory device 330 can program the garbage collection data GC-DATA in the destination block DES in response to the garbage collection write command GC-WT transmitted from the processor 320 (operation 336). When the program is completed, the memory device 330 can notify the processor 320 of the garbage collection program completion GC-WT-C.

The processor 320 can be configured to determine whether the garbage collection is completed (operation 328). When the garbage collection is completed, the processor 320 can update the map data stored in the memory 310 (MAP-UP). A map data update corresponding to garbage collection can be performed on the map data source in the memory 310 (operation 316).

According to an embodiment, while performing garbage collection, the processor 320 can transmit a plurality of garbage collection read commands GC-RD and a plurality of garbage collection write commands GC-WT to the memory device 330. In addition, the processor 320 can alternately transmit the plurality of garbage collection read commands GC-RD and the plurality of garbage collection write commands GC-WT with data input/output commands input from an external device to the memory device 330. The processor 320 can generate, process, and transmit the plurality of garbage collection read commands GC-RD and the plurality of garbage collection write commands GC-WT to the memory device 330 even when the memory device 330 is not in an idle state. In addition, when garbage collection is completed, the processor 320 can perform a map update on the map data source stored in the memory 310. At this time, map updates could be selectively performed in response to write operations among the data input/output operations performed in parallel while the garbage collection is performed.

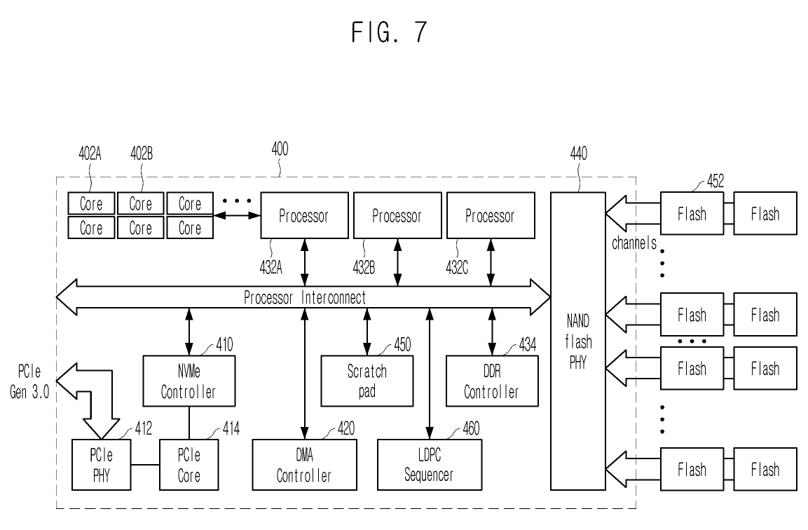

FIG. 7 illustrates a memory system according to an embodiment of the present disclosure.

Specifically, FIG. 7 shows a memory system including multiple cores or multiple processors, which is an example of a data storage system. The memory system may support the Non-Volatile Memory Express (NVMe) protocol.

The NVMe is a type of transfer protocol designed for a solid-state memory that could operate much faster than a conventional hard drive. The NVMe can support higher input/output operations per second (IOPS) and lower latency, resulting in faster data transfer speeds and improved overall performance of the data storage system. Unlike SATA which has been designed for a hard drive, the NVMe can leverage the parallelism of solid-state storage to enable more efficient use of multiple queues and processors (e.g., CPUs). The NVMe is designed to allow hosts to use many threads to achieve higher bandwidth. The NVMe can allow the full level of parallelism offered by SSDs to be fully exploited. However, because of limited firmware scalability, limited computational power, and high hardware contention within SSDs, the memory system might not process a large number of I/O requests in parallel.

Referring to FIG. 7, the host, which is an external device, can be coupled to the memory system through a plurality of PCIe Gen 3.0 lanes, a PCIe physical layer 412, and a PCIe core 414. A controller 400 may include three embedded processors 432A, 432B, 432C, each using a plurality of cores 402A, 402B. Herein, the plurality of cores 402A, 402B or the plurality of embedded processors 432A, 432B, 432C may have a pipeline structure.

The plurality of embedded processors 432A, 432B, 432C may be coupled to an internal DRAM controller (DDR controller) 434 through a processor interconnect. The controller 400 further includes a Low-Density Parity-Check (LDPC) sequencer 460, a Direct Memory Access (DMA) engine 420, a scratch pad memory 450 for metadata management, and an NVMe controller 410. Components within the controller 400 may be coupled to a plurality of channels connected to a plurality of memory packages (Flash) 452 through a flash physical layer (NAND flash PHY) 440. The plurality of memory packages 452 may correspond to the plurality of memory chips 252 described in FIG. 2.

According to an embodiment, the NVMe controller 410 included in the controller 400 is a type of storage controller designed for use with solid state drives (SSDs) that use an NVMe interface. The NVMe controller 410 may manage data transfer between the SSD and the computer CPU as well as other functions such as error correction, wear leveling, and power management. The NVMe controller 410 may use a simplified, low-overhead protocol to support fast data transfer rates.

According to an embodiment, a scratch pad memory 450 may be a storage area set by the NVMe controller 410 to temporarily store data. The scratch pad memory 450 may be used to store data waiting to be written to a plurality of memory packages 452. The scratch pad memory 450 can also be used, typically with a small amount of Dynamic Random Access Memory (DRAM) or Static Random Access Memory (SRAM), as a buffer to speed up the writing process. When a write command is executed, data may first be written to the scratch pad memory 450 and then transferred to the plurality of memory packages 452 in larger blocks. The scratch pad memory 450 may be used as a temporary memory buffer to help optimize the write performance of the plurality of memory packages 452. The scratch pad memory 450 may serve as intermediate storage of data before the data is written to non-volatile memory cells.

The Direct Memory Access (DMA) engine 420 included in the controller 400 is a component that transfers data between the NVMe controller 410 and a host memory in the host system without involving a processor in the host system. The DMA engine 420 can support the NVMe controller 410 to directly read or write data from or to the host memory without intervention of the host’s processor. According to an embodiment, the DMA engine 420 may achieve or support high-speed data transfer between a host and an NVMe device, using a DMA descriptor that includes information regarding data transfer such as a buffer address, a transfer length, and other control information.

The LDPC sequencer 460 in the controller 400 is a component that performs error correction on data stored in the plurality of memory packages 452. Herein, an LDPC code is a type of error correction code commonly used in a NAND flash memory to reduce a bit error rate. The LDPC sequencer 460 may be designed to immediately process encoding and decoding of LDPC codes when reading and writing data from and to the NAND flash memory. According to an embodiment, the LDPC sequencer 460 may divide data into plural blocks, encode each block using an LDPC code, and store the encoded data in the plurality of memory packages 452. Thereafter, when reading the encoded data from the plurality of memory packages 452, the LDPC sequencer 460 can decode the encoded data based on the LDPC code and correct errors that may have occurred during a write or read operation. The LDPC sequencer 460 may correspond to the ECC circuitry 266 described in FIG. 2.

The controllers 130, 230, 400 described in FIGS. 1 to 7 can manage and control status information about memory blocks within the memory devices 150, 250, 452. For example, the controllers 130, 230, 400 can control and update map information for read operations or program operations, and check and update program-erase cycles (P/E Cycles) that estimate or indicate a wear level of memory blocks for wear leveling. Additionally, the controllers 130, 230, 400 can check the read count among the operation information about the memory block. Further, the controllers 130, 230, 400 may have structural information about the internal configuration (e.g., string sharing) of the memory devices 150, 250, 452.

In addition, the controller 130, 230, 400 can be configured to check a valid data ratio, a read count, a program-erase cycle (P/E cycles), or a data retention time among status information regarding the memory block in the memory device 150, 250, 452, and select a source block (or target block) for the garbage collection (GC) based on the checked status information. The controller 130, 230, 400 can be configured to parallel process tasks or operations corresponding to the garbage collection (GC) as well as the data input/output commands transmitted from an external device.

The memory system according to an embodiment of the present disclosure can perform the garbage collection (GC) based on other map data copied from original map data used for plural data input/output operations, and selectively update map data changed or modified by the garbage collection (GC) to the original map data used for the data input/output operations after the garbage collection is terminated, to maintain data consistency. Through this procedure, the memory system can perform the garbage collection during the process of storing data in a memory device through a foggy-and-fine program operation during a data input/output operation, so that there is no need to stop the data input/output operation for the garbage collection, vice versa. Thus, the buffer for the data input/output operation could be used efficiently. In addition, it might be possible to avoid or reduce deterioration of the data input/output performance of the memory system due to the garbage collection.

As above described, a memory device or a memory system according to an embodiment of the present disclosure can independently perform map data management for garbage collection even while continuously performing data input/output operations, thereby avoiding data collisions and maintaining data consistency as well as maintaining or improving I/O operation performance of the memory system.

In addition, a memory device or a memory system according to an embodiment of the present disclosure can avoid or reduce degradation of data input/output performance due to garbage collection, because the garbage collection could be performed even while the memory device or the memory system is not in an idle state.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments, may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, logic, interfaces, decoders, drivers, generators and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, logic, interfaces, decoders, drivers, generators and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments, may transform the computer, processor, controller, or other signal processing device into a special-purpose processor for performing the methods described herein.

While the concepts of the present disclosure have been illustrated and described with respect to specific embodiments, it will be apparent to those skilled in the art in light of the present disclosure that various changes and modifications may be made to the embodiments without departing from the spirit and scope of the disclosure as defined in the following claims. Furthermore, the embodiments may be combined to form additional embodiments.

What is claimed is:

1. A memory system comprising:
a memory device comprising a plurality of data storage areas; and
a controller configured to:
perform a data input/output operation for the plurality of data storage areas based on first map data,
copy the first map data, which is used for the data input/output operation, to generate second map data when determining that garbage collection is to be performed for at least one of the plurality of data storage areas,
perform the garbage collection based on the second map data, and
selectively update the first map data based on the second map data, which is modified by the garbage collection, based on a result of the data input/output operation.

2. The memory system according to claim 1, wherein the controller is configured to perform the garbage collection while performing the data input/output operation.

3. The memory system according to claim 2, wherein the controller is configured to perform the garbage collection regardless of whether the memory system is in an idle state.

4. The memory system according to claim 1, wherein, when both the data input/output operation and the garbage collection are concurrently performed for a same logical address, the controller is configured to update the first map data based on the data input/output operation and avoid updating the first map data based on the second map data which has been modified even by the garbage collection.

5. The memory system according to claim 1, wherein, when the data input/output operation and the garbage collection are performed for different logical addresses, the controller is configured to update the first map data based on the second map data modified by the garbage collection.

6. The memory system according to claim 1, wherein the controller is further configured to:
determine a source block or a target block for the garbage collection based on the second map data; and
copy valid data from the source block or the target block to a destination block.

7. The memory system according to claim 6, wherein the controller is further configured to perform an erase operation for the source block after the valid data is copied to the destination block.

8. The memory system according to claim 6, wherein the controller is configured to:
select at least one of closed memory blocks as the source block or the target block, and
select, as the destination block, at least one of open memory blocks on which a write operation is performed during the data input/output operation.

9. The memory system according to claim 1, wherein the controller is configured to read and copy only valid data stored in the source block or the target block during the garbage collection.

10. The memory system according to claim 1, wherein, when both the data input/output operation and the garbage collection are concurrently performed for a same logical address, the controller is configured to avoid copying data associated with the same logical address from a source block or a target block to a destination block during the garbage collection.

11. A memory controller comprising:
a first pipeline configured to process or carry out a data input/output command transmitted from a host and use first map data for a data input/output operation corresponding to the data input/output command; and
a second pipeline distinct from the first pipeline and configured to:
copy the first map data to generate second map data,
perform garbage collection for at least one memory device based on the second map data, and
update the first map data based on results of the garbage collection and the data input/output operation.

12. The memory controller according to claim 11, wherein the second pipeline performs the garbage collection while the first pipeline performs the data input/output operation.

13. The memory controller according to claim 11, wherein the first pipeline processes or carries out the data input/output command while the second pipeline performs the garbage collection.

14. The memory controller according to claim 11, wherein the first map data is updated by the first pipeline, after the first pipeline performs a write operation corresponding to a write command regarded as the data input/output command for a logical address while the second pipeline performs the garbage collection for the logical address.

15. The memory controller according to claim 11, wherein the first map data is updated by both the first pipeline and the second pipeline, after the first pipeline performs a write operation corresponding to a write command regarded as the data input/output command for a logical address while the second pipeline performs the garbage collection for a different logical address.

16. The memory controller according to claim 11, wherein the second pipeline is configured to:
determine a source block or a target block for the garbage collection based on the second map data; and
copy valid data from the source block or the target block to a destination block.

17. The memory controller according to claim 16, wherein the second pipeline is configured to read and copy only valid data from the source block or the target block during the garbage collection.

18. A method for operating a memory system, the method comprising:
receiving a data input/output command from a host;
performing a data input/output operation corresponding to the data input/output command based on first map data;
determining whether to perform garbage collection regardless of whether to perform the data input/output operation;
copying, for the garbage collection, the first map data to generate second map data;
performing the garbage collection based on the second map data; and
performing map update of the first map data, used through the data input/output operation, based on a result of the garbage collection.

19. The method according to claim 18, wherein the map update of first map data is performed by the data input/output operation performed corresponding to a write command regarded as the data input/output command for a logical address while the garbage collection is performed for the logical address.

20. The method according to claim 18, wherein the map update of first map data is performed by the data input/output operation and the garbage collection after a write operation is performed corresponding to a write command regarded as the data input/output command for a logical address while the garbage collection is performed for a different logical address.
